(19) United States
(12) Patent Application Publication
(10) Pub. No.: US 2007/0101064 A1
(43) Pub. Date: May 3, 2007

(54) Cache controller and method

(75) Inventors: Frederic Claude Piry, Fleuris (FR); Philippe Jean-Pierre Raphalen, Valbonne (FR); Gilles Eric Grandou, Plascassier (FR)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/264,374

(22) Filed: Nov. 2, 2005

(51) Int. Cl. G06F 12/00

(52) U.S. Cl. 711/128

(57) ABSTRACT

There is disclosed a method, a cache controller and a data processing apparatus for allocating a data value to a cache way. The method comprises the steps of: (i) receiving a request to allocate the data value to an ‘n’-way set associative cache in which the data value may be allocated to a corresponding cache line of any one of the ‘n’-ways, where ‘n’ is an integer greater than 1; (ii) reviewing attribute information indicating whether the corresponding cache line of any of the ‘n’-ways is clean; and (iii) utilising the attribute information when executing a way allocation algorithm to provide an increased probability that the data value is allocated to a clean corresponding cache line. By allocating data value to the corresponding clean cache line there is no need to evict any data values prior to the allocation occurring, this obviates the need to power the eviction infrastructure and reduces eviction traffic over any interconnect. It will be appreciated that this can significantly reduce power consumption and improve the performance of the system.

### FIELD OF THE INVENTION

The present invention relates to a cache controller and method.

### BACKGROUND OF THE INVENTION

Cache controllers are known. A cache is typically used to provide a local store of data values for use by a processor core. It is known to provide a cache in order to improve the performance of a processor core when executing a sequence of instructions since the cache can provide a local copy of data values such that these data values are available to the processor core when required, rather than having to access a slower, lower-level memory.

In order to maintain fast access times and to reduce power consumption, the size of the cache is typically limited. Accordingly, given the cache's finite size, it is apparent that there will come a time when the cache becomes full and data values within the cache will need to be overwritten.

When the cache provided is a so-called “n”-way set associative cache, a data value may be written at an appropriate index of any one of the “n” ways. Allocation algorithms exist which determine which of the “n” ways should be allocated to store the data value. The algorithms are responsive to a predetermined replacement policy which determines which existing data value in the “n” ways should be replaced with the new data value and, hence, which way should be allocated to store the data value.

Typical replacement policies include “not most recently used”, “round robin” or random replacement. Whilst each of these replacement policies have particular advantages, they each also have certain performance shortfalls.

Accordingly, it is desired to provide a technique for allocating a cache way for a data value.

### SUMMARY OF THE INVENTION

According to a first aspect of the present invention, there is provided a method of allocating a data value to a cache way, the method comprising the steps of: (i) receiving a request to allocate the data value to an ‘n’-way set associative cache in which the data value may be allocated to a corresponding cache line of any one of the ‘n’-ways, where ‘n’ is an integer greater than 1; (ii) reviewing attribute information indicating whether the corresponding cache line of any of the ‘n’-ways is clean; and (iii) utilising the attribute information when executing a way allocation algorithm to provide an increased probability that the data value is allocated to a clean corresponding cache line.

The present invention recognises that whilst many cache way allocation algorithms seek to optimise the performance of the processor core, this can be to the determent of the performance of other parts of the overall system. The present invention also recognises that this poor performance can be due to the occurrence of evictions caused by data values being allocated to dirty lines within the cache. When data values are allocated to a cache line in a cache way and the data values in that cache line is dirty, the dirty data values must be evicted from the cache prior to the new data values being allocated. Whilst this does not necessarily immediately impact on the performance of the processor core because infrastructure is provided (such as eviction buffers) into which the evicted data values may be stored (thereby maintaining the performance of the processor core), the eviction infrastructure consumes power and eventually, the evicted data values must be written to a lower-level memory (for example, a level two, three or four memory) which also consumes power and takes time.

The present invention also recognises that it is often the case that there will be a bandwidth bottleneck in any interconnect coupling the processor core with the lower-level memory. In multiple-processor systems, this bandwidth bottleneck becomes even more acute. Whilst eviction buffers may be used to smooth out any performance difficulties and optimisations can be provided when transferring evicted data values over the interconnect, it will be appreciated that such evictions will inevitably increase the traffic on the interconnect and reduce its utilisation for other activities, some of which may be vital to the performance of the processor core.

Accordingly, attribute information is reviewed in order to determine whether any of the cache ways into which the data value may be allocated is clean. This attribute information is then used by a way allocation algorithm in order to provide an increased likelihood that a clean corresponding cache line is allocated. By allocating data value to the corresponding clean cache line there is no need to evict any data values prior to the allocation occurring, this obviates the need to power the eviction infrastructure and reduces eviction traffic over any interconnect. It will be appreciated that this can significantly reduce power consumption and improve the performance of the system.

In one embodiment, the step (iii) comprises utilising the attribute information to generate an allocatable group of corresponding cache lines from which the way allocation algorithm may select, the allocatable group including at least a number of the clean corresponding cache lines.

Accordingly, an allocatable group of cache lines is generated from which the way allocation algorithm may select. The allocatable group includes at least some of any corresponding cache lines which are clean. By including these clean cache lines in the group, the probability that data value is allocated to a clean cache line is increased.

In one embodiment the step (iii) comprises utilising the attribute information to generate an allocatable group of corresponding cache lines from which the way allocation algorithm may select, the allocatable group including at least all of the clean corresponding cache lines.

By including in the group all of the cache lines which are clean, the likelihood that a clean cache line is selected is further increased.

In one embodiment, the step (iii) comprises utilising the attribute information to generate an allocatable group of corresponding cache lines from which the way allocation algorithm may select, the allocatable group including at least all of the clean corresponding cache lines and at least one dirty corresponding cache line.

By including in the allocatable group not only clean cache lines but also at least one of any dirty cache lines ensures that whilst the probability of selecting a clean cache line is increased, there is a reduced probability that a dirty cache line is never selected for allocation which would otherwise reduce the effective number of ways available for allocation.

In one embodiment the step (iii) comprises utilising the attribute information to generate an allocatable group of corresponding cache lines from which the way allocation algorithm may select, the allocatable group including at least all of the clean corresponding cache lines and at least one dirty corresponding cache line, the at least one dirty corresponding cache line being a different dirty corresponding cache line each time the allocatable group is generated.

Where more than one dirty line exists, the allocatable group may be altered each time the allocation algorithm is used in order to include a different one of the dirty lines. It will be appreciated that this will require some historic information to be retained indicating which dirty line have been included previously in the allocatable group. In this way, it is possible to ensure that the effective number of available ways is not reduced.

In one embodiment the step (iii) comprises utilising the attribute information to generate a non-allocatable group of corresponding cache lines from which the way allocation algorithm may not select, the non-allocatable group including at least one of any dirty corresponding cache lines.

Accordingly, a group of cache lines which the way allocation algorithm may not select may be provided and this group may include at least one dirty line, if any such corresponding dirty cache line exists. It will be appreciated that this improves the probability that the way allocation algorithm selects a clean line.

In one embodiment, the step (iii) comprises utilising the attribute information to generate a non-allocatable group of corresponding cache lines from which the way allocation algorithm may not select, the non-allocatable group including at least a most recently loaded corresponding cache line.

Accordingly, included in the non-allocatable group is the most recently loaded cache line. Including the most recently loaded cache line in the non-allocatable group helps to ensure that this cache line will not be allocated. This is likely to help improve the performance of the processor core since it is often the case that the most recently loaded cache line is often likely to be the most likely cache line to be utilised by a processor core.

In one embodiment, the attribute information indicates that a cache line is clean if the attribute information does not indicate that the cache line is dirty.

Accordingly, even if an attribute is not provided which positively indicates that a cache line is clean, this information can be inferred from attributes indicating that a cache line is dirty.

In one embodiment the step (iii) comprises utilising the attribute information when executing the way allocation algorithm to provide a decreased probability that the data value is allocated to a dirty corresponding cache line.

Accordingly, the attribute information can be utilised by the way allocation algorithm to reduce the likelihood that the data value is allocated to a dirty cache line. Reducing the likelihood that the data value is allocated to a dirty cache line reduces the probability that an eviction will need to occur.

In one embodiment the step (iii) comprises utilising the attribute information when executing the way allocation algorithm to provide a decreased probability that the data value is allocated to a most recently allocated corresponding cache line.

Accordingly, the attribute information may be used to ensure that the likelihood that the most recently allocated cache line is selected can be reduced. As mentioned previously, it is desirable to avoid allocating data values to the most recently used cache line since it is likely that most recently used cache line will need to be accessed by the processor core.

In one embodiment, the step (iii) comprises utilising the attribute information when executing the way allocation algorithm to increase the number of instances of clean corresponding caches lines available for selection by the way allocation algorithm to provide the increased probability that the data value is allocated to a clean corresponding cache line.

Accordingly, in arrangements where the algorithm performs the selection by selecting from a predetermined number of entries, each of which include a possible cache way for selection, by increasing the instances of entries corresponding to clean cache lines the probability that data is allocated to a clean cache line is increased.

In one embodiment the step (iii) comprises utilising the attribute information when executing the way allocation algorithm to decrease the number of instances of dirty corresponding caches lines available for selection by the way allocation algorithm to provide a decreased probability that the data value is allocated to a dirty corresponding cache line.

Accordingly, by decreasing the number of instances of dirty cache lines from which the algorithm may select reduces the likelihood that a dirty cache line is selected for allocation.

According to a second aspect of the present invention there is provided a cache controller operable to allocate a data value to a cache way, the cache controller comprising: reception logic operable to receive a request to allocate the data value to an ‘n’-way set associative cache in which the data value may be allocated to a corresponding cache line of any one of the ‘n’-ways, where ‘n’ is an integer greater than 1; review logic operable to review attribute information indicating whether the corresponding cache line of any of the ‘n’-ways is clean; and way allocation logic operable to utilise the attribute information when executing a way allocation algorithm to provide an increased probability that the data value is allocated to a clean corresponding cache line.

According to a third aspect of the present invention there is provided A data processing apparatus comprising: at least one processor core for processing data values; at least one an ‘n’-way set associative cache in which a data value may be allocated to a corresponding cache line of any one of said ‘n’-ways, where ‘n’ is an integer greater than 1; and a cache controller for allocating said data value to a cache way, said cache controller comprising: reception means for receiving a request to allocate said data value to said cache; review means for reviewing attribute information indicating whether said corresponding cache line of any of said ‘n’-ways is clean; and way allocation means for utilising said attribute information when executing a way allocation algorithm to provide an increased probability that said data value is allocated to a clean corresponding cache line.

In embodiments, there is provided a data processing apparatus comprising features of the cache controller according to the second aspect of the present invention.

### BRIEF DESCRIPTION OF THE DRAWINGS

Embodiments of the present invention will now be described with reference to the accompanying drawings in which:

FIG. 1 illustrates a data processing apparatus incorporating a cache controller according to an embodiment of the present invention;

FIG. 2 is a flow chart illustrating the operation of the data processing apparatus incorporating the cache controller of FIG. 1; and

FIG. 3 schematically illustrates example operations of the cache controller of FIG. 1 when executing way allocation algorithms.

### DESCRIPTION OF THE EMBODIMENTS

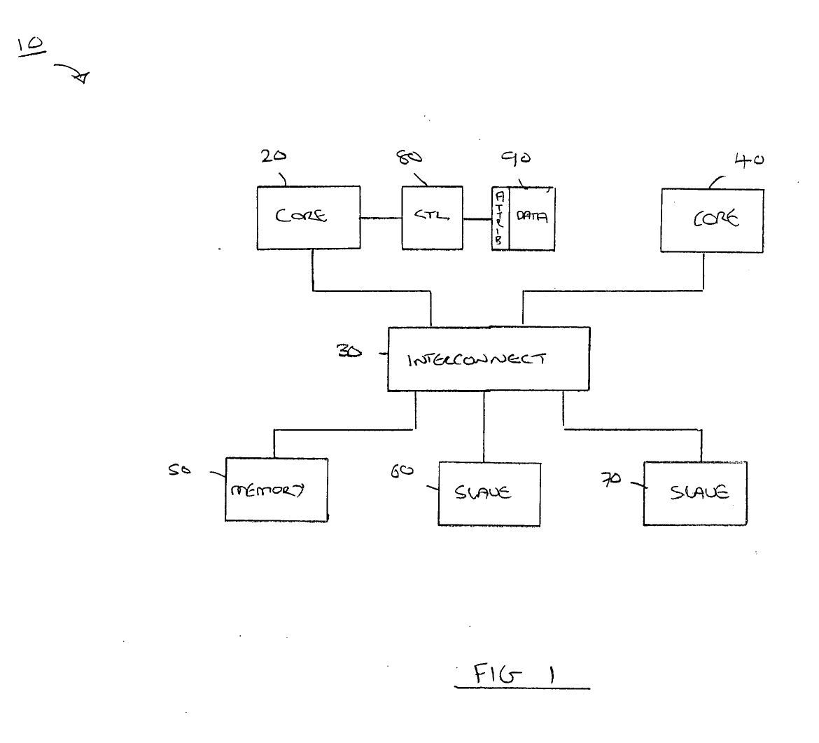

FIG. 1 illustrates a data processing apparatus, generally 10, according to one embodiment. The data processing apparatus 10 comprises a processor core 20 coupled with an interconnect 30. Also coupled with the interconnect 30 is a further processor core 40. A memory unit 50, together with slave devices 60 and 70 are also coupled with the interconnect 30.

The processor cores 20, 40 can be considered as master units and the memory 50, and the slave units 60 and 70 can be considered as slave units. It will be appreciated that more than the illustrated master units and slave units may be provided in a data processing apparatus. The master units are coupled with the slave units using the interconnect 30.

Each master unit may initiate a request to transfer one or more data values between that master unit and one or more of the slave units. The interconnect 30 contains logic which is responsive to those requests and is configurable to enable data values to be transferred between the master units and the slave units. The bandwidth provided by the interconnect 30 is finite and accordingly there is a limit on the quantity of data values which can be transferred using the interconnect at any one time.

The processor core 20 is coupled with a cache controller 80 which in turn interfaces with a cache 90. Although not shown, the processor core 40 may also have a similar cache controller and cache.

The cache controller 80 receives requests from the processor core 20 to access data values. The cache controller 80 performs a cache-lookup in the cache 90 in response to those access requests. In the event that a cache hit occurs then the access request made by the processor core 20 will proceed.

Attribute data is provided within the cache 90 which is associated with data values stored in the cache lines of the cache 90. The attribute data includes an indication of whether the corresponding cache line is valid or not, and also whether the data values in that cache line are dirty or not. The use of such attribute information is well known in the art. A cache line is typically set as dirty when the data values stored therein have been modified and the modified data values have not yet been provided to a lower-level memory. Accordingly, setting the attribute data to indicate that a cache line is dirty will indicate that the cache line should not be overwritten until that cache line has been evicted from the cache in order that the lower-level memory may be updated with those modified data values.

In normal operation the bandwidth provided by the interconnect 30 will be typically utilised to transfer data values between the master units and the slave units. A proportion of that traffic will relate to data values being retrieved from slave units for allocation to the cache of the requesting master unit. However, a proportion of the traffic will also relate to dirty data values which are being evicted from a cache in order to make room for data values to be allocated to the cache.

Accordingly, the cache controller 80 seeks to minimise the number of evictions which need to be made from the cache 90 in order to reduce the traffic over the interconnect 30. It will be appreciated that reducing the amount of eviction traffic over the interconnect 30 increases the available bandwidth for other traffic. Also, by reducing the number of evictions from the cache 90 the amount of power consumed as a result of processing evictions is reduced. The cache controller 80 minimises the number of evictions made by utilising a way selection algorithm which biases the way selection towards selecting a clean cache line in preference to a dirty cache line, as will be explained in more detail below.

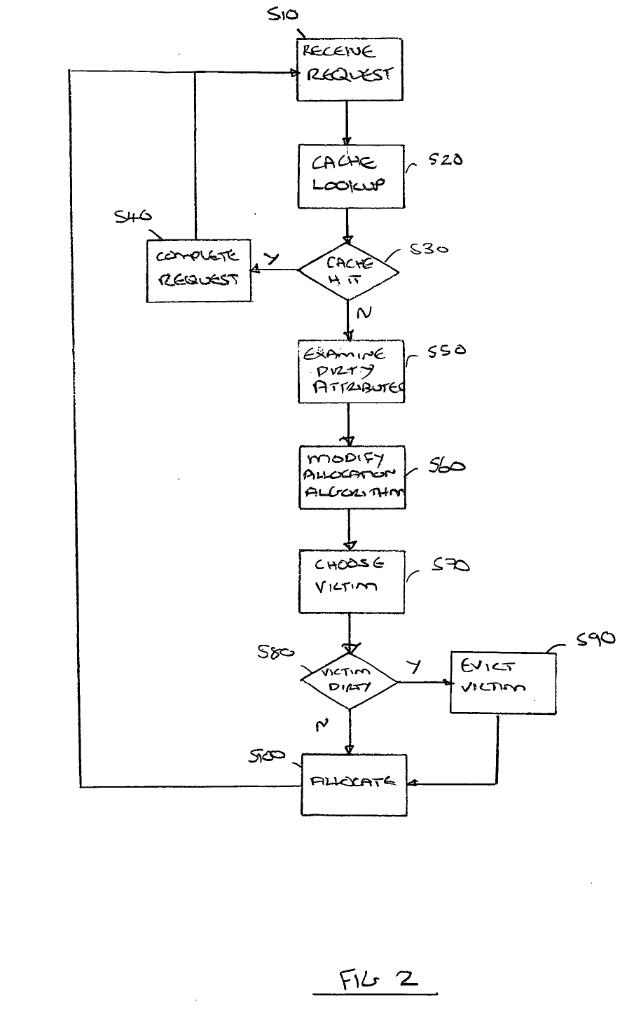

FIG. 2 illustrates in more detail the operation of the cache controller 80.

At step S10, the cache controller 80 receives an access request from the processor core 20.

At step S20, the cache controller 80 performs a cache look up in the cache 90 in response to the access request.

At step S30, the cache controller 80 determines whether a cache hit has occurred (indicating that the data values the subject of the access request is currently stored in the cache 90).

If a cache hit occurs then, at step S40, the access request is completed. In particular, if the access request is a read request then the requested data value is read from the cache 90 and provided to the processor core 20. In the event that the access request is a write request then the data value is written to the cache 90 and the attributes of that cache line are updated accordingly.

If a cache miss occurs then this indicates that the data value of the subject of the access request is not currently stored in the cache 90 and a cache line in one of the cache ways needs to be selected for allocation. Accordingly, at step S50, the cache controller 80 will review the attribute information associated with the cache line in each of the cache ways which could be selected for allocation. In particular, the dirty attribute information of the cache line in each of the cache ways is determined.

At step S60, the way allocation algorithm used by the cache controller 80 is modified to take account of the dirty attribute information in order to increase the likelihood that a dirty cache line is not selected for allocation. It will be appreciated that in order to reduce the amount of eviction traffic it is not necessary to completely eliminate evictions altogether, some performance benefit can be still achieved by simply reducing the overall number of evictions which occur. Hence, it is not necessary (and indeed it would be undesirable) for dirty cache lines to never be selected for allocation since this would effectively reduce the number of cache ways available for allocation and may impact on the performance of the processor core 20.

Once the way allocation algorithm has been modified then, at step S70, a victim cache line is selected for eviction using the way allocation algorithm.

At step S80, a determination is made as to whether the victim cache line is dirty or not. In the event that the victim cache line is dirty, then at step S90, that cache line is evicted and the access request is allowed to complete with the new data values being allocated to the selected cache way.

In the event that the victim cache line is not dirty then the data values are allocated to the cache line of that selected cache way and eviction need not occur, the data values stored in the cache line of that cache way can be simply overwritten.

By modifying the way allocation algorithm to increase the probability that a clean cache way is selected for allocation, the statistical likelihood that step S90 will need to be performed is reduced. Hence, the amount of evictions which will also be reduced, the amount of traffic occurring over the interconnect 30 is reduced and the power and resources consumed evicting dirty data is reduced.

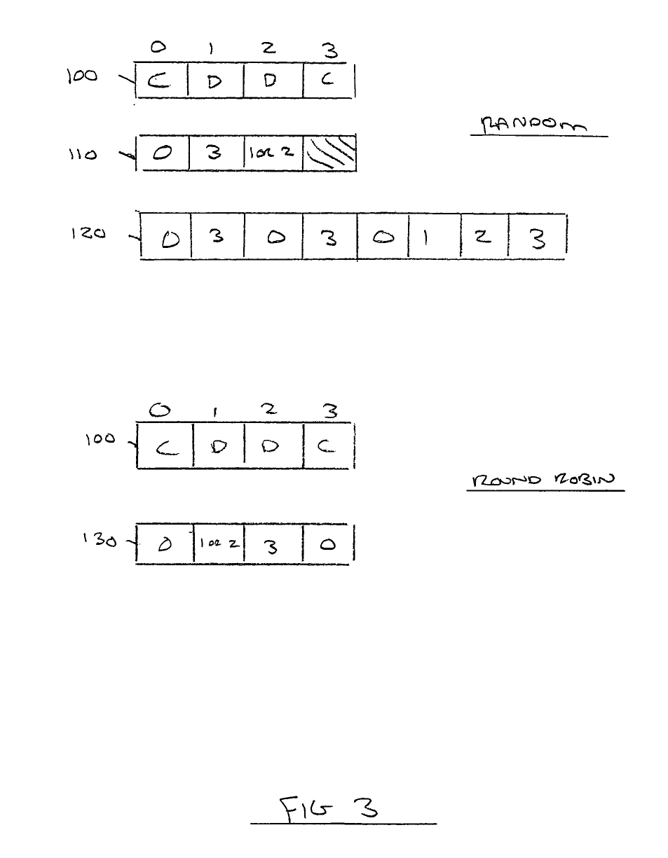

FIG. 3 illustrates in more detail examples of how a way selection algorithm may be modified, fitted or weighted using the dirty attribute information.

It will be appreciated that the way allocation algorithm could be based upon any number of allocation policies such as, least recently used, random allocation, round robin allocation, last-in first-out, first-in first-out or last-in last-out, etc.

A portion of FIG. 3 illustrates how an example random policy way allocation algorithm can be modified in order to increase the likelihood that a dirty cache line is not selected. Assuming that the cache 90 is a four way set-associative cache then the attribute information for the corresponding cache line in each of the four cache ways is retrieved and stored in a register 100.

A way selection register 110 or 120 is provided from which the way allocation algorithm will randomly select an entry. The way selection register 110 or 120 is populated in a manner which makes the selection of a clean way more likely than a dirty way. In this example, way 0 and 3 are indicated to be clean by the register 100.

When using the way allocation register 110, the clean ways are populated into the first two entries. Thereafter, in the next entry of the way allocation register 110, one of the dirty ways will be populated. Any remaining entries in the way allocation register 110 will be nulled.

Accordingly, when executing the way allocation algorithm, a random selection will be made from the three available entries in the way allocation register 110. As a result, it can be seen that the probability that a dirty way is selected from the way allocation register 110 has been reduced from a 50% chance to a 33% chance. Hence, the likelihood that a dirty way is selected is reduced and the chance that a clean way is selected is increased.

Alternatively, when a way allocation register 120 is used, the entries of the first half of the register 120 will be filled with ways which have been determined to be clean (in this example ways 0 and 3) with the other half of the register entries being filled with ways 0 to 3.

Accordingly, when the way selection algorithm makes a random selection of an entry from within the way allocation register 120 there is an increased probability that a clean way will be selected (75% instead of 50%).

As indicated previously, the population of the way selection register 110 and/or the way allocation register 120 could be made to change the dirty way selected for inclusion in that register in order to avoid a situation whereby there is a chance that dirty data values in the cache 90 will never be evicted, which would otherwise reduce the number of evictive ways available. Selecting a different dirty way for inclusion can simply be performed by providing an indication of whether or not a dirty way was selected previously.

In an alternative round robin approach, the register 100 receives an indication of the status attributes of each of the cache ways as before. Thereafter, the way allocation register 130 is populated with a clean way, one of the two dirty ways, the next clean way and then a further clean way on a cycling basis. Accordingly, in this way, the probability that a clean way is selected is also increased (75% instead of 50%).

Similarly, the population of the way allocation register 130 could be made to change the dirty way selected for inclusion in that register in order to avoid a situation whereby there is a chance that dirty data values in the cache 90 will never be evicted, which would otherwise reduce the number of evictive ways available. Again, selecting a different dirty way for inclusion can simply be performed by providing an indication of whether or not a dirty way was selected previously.

Accordingly, the present technique seeks to provide an enhanced probability that when a data value needs to be allocated to a cache, the cache line selected in the cache for allocation is clean. Allocating data values to a clean cache line removes the need to evict any data values prior to the allocation occurring. Such an approach removes the need to power the eviction infrastructure. Also, the amount of eviction traffic required to be provided over any interconnect is reduced. It will be appreciated that reducing interconnect traffic may be particular beneficial in multiple master, multiple slave systems. Hence, power consumption can be reduced, interconnect bandwidth limitations obviated and the overall performance of the system improved.

Although a particular embodiment of the invention has been described herewith, it will be apparent that the invention is not limited thereto, and that many modifications and additions may be made within the scope of the invention. For example, various combinations of the features from the following dependent claims could be made with features of the independent claims without departing from the scope of the present invention.

We claim:

1. A method of allocating a data value to a cache way, said method comprising the steps of:
(i) receiving a request to allocate said data value to an ‘n’-way set associative cache in which said data value may be allocated to a corresponding cache line of any one of said ‘n’-ways, where ‘n’ is an integer greater than 1;
(ii) reviewing attribute information indicating whether said corresponding cache line of any of said ‘n’-ways is clean; and
(iii) utilising said attribute information when executing a way allocation algorithm to provide an increased probability that said data value is allocated to a clean corresponding cache line.

2. The method of claim 1, wherein said step (iii) comprises:
utilising said attribute information to generate an allocatable group of corresponding cache lines from which said way allocation algorithm may select, said allocatable group including at least a number of said clean corresponding cache lines.

3. The method of claim 1, wherein said step (iii) comprises:
utilising said attribute information to generate an allocatable group of corresponding cache lines from which said way allocation algorithm may select, said allocatable group including at least all of said clean corresponding cache lines.

4. The method of claim 1, wherein said step (iii) comprises:
utilising said attribute information to generate an allocatable group of corresponding cache lines from which said way allocation algorithm may select, said allocatable group including at least all of said clean corresponding cache lines and at least one dirty corresponding cache line.

5. The method of claim 1, wherein said step (iii) comprises:
utilising said attribute information to generate an allocatable group of corresponding cache lines from which said way allocation algorithm may select, said allocatable group including at least all of said clean corresponding cache lines and at least one dirty corresponding cache line, said at least one dirty corresponding cache line being a different dirty corresponding cache line each time said allocatable group is generated.

6. The method of claim 1, wherein said step (iii) comprises:
utilising said attribute information to generate a non-allocatable group of corresponding cache lines from which said way allocation algorithm may not select, said non-allocatable group including at least one of any dirty corresponding cache lines.

7. The method of claim 1, wherein said step (iii) comprises:
utilising said attribute information to generate a non-allocatable group of corresponding cache lines from which said way allocation algorithm may not select, said non-allocatable group including at least a most recently loaded corresponding cache line.

8. The method of claim 1, wherein said attribute information indicates that a cache line is clean if said attribute information does not indicate that said cache line is dirty.

9. The method of claim 1, wherein said step (iii) comprises:
utilising said attribute information when executing said way allocation algorithm to provide a decreased probability that said data value is allocated to a dirty corresponding cache line.

10. The method of claim 1, wherein said step (iii) comprises:
utilising said attribute information when executing said way allocation algorithm to provide a decreased probability that said data value is allocated to a most recently allocated corresponding cache line.

11. The method of claim 1, wherein said step (iii) comprises:
utilising said attribute information when executing said way allocation algorithm to increase the number of instances of clean corresponding caches lines available for selection by said way allocation algorithm to provide said increased probability that said data value is allocated to a clean corresponding cache line.

12. The method of claim 1, wherein said step (iii) comprises:
utilising said attribute information when executing said way allocation algorithm to decrease the number of instances of dirty corresponding caches lines available for selection by said way allocation algorithm to provide a decreased probability that said data value is allocated to a dirty corresponding cache line.

13. A cache controller operable to allocate a data value to a cache way, said cache controller comprising:
reception logic operable to receive a request to allocate said data value to an ‘n’-way set associative cache in which said data value may be allocated to a corresponding cache line of any one of said ‘n’-ways, where ‘n’ is an integer greater than 1;
review logic operable to review attribute information indicating whether said corresponding cache line of any of said ‘n’-ways is clean; and
way allocation logic operable to utilise said attribute information when executing a way allocation algorithm to provide an increased probability that said data value is allocated to a clean corresponding cache line.

14. The cache controller of claim 13, wherein said way allocation logic is operable to utilise said attribute information to generate an allocatable group of corresponding cache lines from which said way allocation algorithm may select, said allocatable group including at least a number of said clean corresponding cache lines.

15. The cache controller of claim 13, wherein said way allocation logic is operable to utilise said attribute information to generate an allocatable group of corresponding cache lines from which said way allocation algorithm may select, said allocatable group including at least all of said clean corresponding cache lines.

16. The cache controller of claim 13, wherein said way allocation logic is operable to utilise said attribute information to generate an allocatable group of corresponding cache lines from which said way allocation algorithm may select, said allocatable group including at least all of said clean corresponding cache lines and at least one dirty corresponding cache line.

17. The cache controller of claim 13, wherein said way allocation logic is operable to utilise said attribute information to generate an allocatable group of corresponding cache lines from which said way allocation algorithm may select, said allocatable group including at least all of said clean corresponding cache lines and at least one dirty corresponding cache line, said at least one dirty corresponding cache line being a different dirty corresponding cache line each time said allocatable group is generated.

18. The cache controller of claim 13, wherein said way allocation logic is operable to utilise said attribute information to generate a non-allocatable group of corresponding cache lines from which said way allocation algorithm may not select, said non-allocatable group including at least one of any dirty corresponding cache lines.

19. The cache controller of claim 13, wherein said way allocation logic is operable to utilise said attribute information to generate a non-allocatable group of corresponding cache lines from which said way allocation algorithm may not select, said non-allocatable group including at least a most recently loaded corresponding cache line.

20. The cache controller of claim 13, wherein said attribute information indicates that a cache line is clean if said attribute information does not indicate that said cache line is dirty.

21. The cache controller of claim 13, wherein said way allocation logic is operable to utilise said attribute information when executing said way allocation algorithm to provide a decreased probability that said data value is allocated to a dirty corresponding cache line.

22. The cache controller of claim 13, wherein said way allocation logic is operable to utilise said attribute information when executing said way allocation algorithm to provide a decreased probability that said data value is allocated to a most recently allocated corresponding cache line.

23. The cache controller of claim 13, wherein said way allocation logic is operable to utilise said attribute information when executing said way allocation algorithm to increase the number of instances of clean corresponding caches lines available for selection by said way allocation algorithm to provide said increased probability that said data value is allocated to a clean corresponding cache line.

24. The cache controller of claim 13, wherein said way allocation logic is operable to utilise utilising said attribute information when executing said way allocation algorithm to decrease the number of instances of dirty corresponding caches lines available for selection by said way allocation algorithm to provide a decreased probability that said data value is allocated to a dirty corresponding cache line.

25. A data processing apparatus comprising:
at least one processor core for processing data values;
at least one an ‘n’-way set associative cache in which a data value may be allocated to a corresponding cache line of any one of said ‘n’-ways, where ‘n’ is an integer greater than 1; and
a cache controller for allocating said data value to a cache way, said cache controller comprising:
reception means for receiving a request to allocate said data value to said cache;
review means for reviewing attribute information indicating whether said corresponding cache line of any of said ‘n’-ways is clean; and
way allocation means for utilising said attribute information when executing a way allocation algorithm to provide an increased probability that said data value is allocated to a clean corresponding cache line.

26. The data processing apparatus of claim 25, wherein said at least one processor core comprises a plurality of processor cores, said data processing apparatus further comprising:
at least one memory unit for storing data values evicted from said plurality of processor cores; and
interconnect logic for coupling said plurality of processor cores with said at least one memory unit, wherein way allocation logic is for utilising said attribute information when executing a way allocation algorithm to provide an increased probability that said data value is allocated to a clean corresponding cache line thereby reducing the quantity of evicted data values transferred by said interconnect logic.
